(19) United States
(12) Patent Application Publication
(10) Pub. No.: US 2013/0311272 A1
(43) Pub. Date: Nov. 21, 2013

(54) METHOD AND SYSTEM FOR DYNAMICALLY OPTIMIZING PROFIT FOR GUARANTEED DEAL BIDDING

(71) Applicants: Raju BALAKRISHNAN, Tempe, AZ (US); Rushi P. BHATT, Surat (IN)

(72) Inventors: Raju BALAKRISHNAN, Tempe, AZ (US); Rushi P. BHATT, Surat (IN)

(73) Assignee: YAHOO! INC., Sunnyvale, CA (US)

(21) Appl. No.: 13/472,482

(22) Filed: May 16, 2012

(51) Int. Cl. G06Q 30/02

(52) U.S. Cl. 705/14.46

(57) ABSTRACT

A computer-implemented method of optimizing real time profit for guaranteed deal bidding includes receiving a plurality of inputs for a guaranteed deal. The computer-implemented method also includes formulating an expected profit for the guaranteed deal based on the plurality of inputs. Further, the computer-implemented method includes optimizing the expected profit dynamically by varying a bid amount. Furthermore, the computer-implemented method includes rendering an advertisement corresponding to a bidder to attain a maximum profit.

### TECHNICAL FIELD

Embodiments of the disclosure relate generally, to web technology and more specifically, to dynamically optimize profit for guaranteed deal bidding.

### BACKGROUND

Displaying online advertisements is a key technology in the web today. A significant emerging trend in the technology is advertisement (ad) and deal campaigns. Further, the ad and deal campaigns require guarantees of minimum number of clicks, conversions and displays within a fixed time period. Such ad and deal campaigns are termed as guaranteed deals. For example, Groupon is a guaranteed deal that requires minimum number of sign-ups before the deal expires. In such ad and deal campaigns, it is necessary to maximize the profit. In order to maximize the profit, bidders need to bid low but still need to satisfy the guarantees before the deal expires. In contradiction, when bidders bid high, the profit reduces. However, chances of satisfying the guarantees increase. Consequently, bidding high or low values appear to be conflicting.

Currently, dynamic bidding is also popular. Here, a stock market is in place. For example, as a user visits a web page, a message is sent to the advertisers. At this instant, an advertiser who bids the highest gets to display a corresponding advertisement to the user. However, dynamic bidding is constrained with factors such as time period and a preset guarantee. Bidding with the factors has become challenging.

In light of the foregoing discussion, there is a need for an efficient method and system for dynamically optimizing profit for guaranteed deal bidding.

### SUMMARY

The above-mentioned needs are met by a computer-implemented method, computer program product, and system for dynamically optimizing profit for guaranteed deal bidding.

An example of a computer-implemented method for dynamically optimizing profit for guaranteed deal bidding includes receiving a plurality of inputs for a guaranteed deal. The computer-implemented method also includes formulating an expected profit for the guaranteed deal based on the plurality of inputs. Further, the computer-implemented method includes optimizing the expected profit dynamically by varying a bid amount. Furthermore, the computer-implemented method includes rendering an advertisement corresponding to a bidder to attain a maximum profit.

An example of a computer program product stored on a non-transitory computer-readable medium that when executed by a processor, performs a method for dynamically optimizing profit for guaranteed deal bidding includes receiving a plurality of inputs for a guaranteed deal. The computer program product also includes formulating an expected profit for the guaranteed deal based on the plurality of inputs. Further, the computer program product includes optimizing the expected profit dynamically by varying a bid amount. Furthermore, the computer program product includes rendering an advertisement corresponding to a bidder to attain a maximum profit.

An example of a system for dynamically optimizing profit for guaranteed deal bidding includes a web interface that receives a plurality of inputs for a guaranteed deal. The system also includes a database, communicatively coupled to the web interface that stores the plurality of inputs. Further, the system includes an ad server, communicatively coupled to the web interface, the ad server to store advertisements and to render the advertisements.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a flow diagram illustrating a method of dynamically optimizing profit for guaranteed deal bidding, in accordance with one embodiment;

FIG. 2 is a block diagram illustrating a system for dynamically optimizing profit for guaranteed deal bidding, in accordance with one embodiment; and

FIG. 3 is a block diagram illustrating an exemplary computing device, in accordance with one embodiment.

### DETAILED DESCRIPTION OF THE EMBODIMENTS

A computer-implemented method, computer program product, and system for dynamically optimizing profit for guaranteed deal bidding are disclosed. The following detailed description is intended to provide example implementations to one of ordinary skill in the art, and is not intended to limit the invention to the explicit disclosure, as one or ordinary skill in the art will understand that variations can be substituted that are within the scope of the invention as described.

Advertisements require guarantees of minimum number of target events before a deal expiry. Examples of the target events include, but are not limited to, conversions, clicks and displays. Such a deal is herein referred to as guaranteed deal.

A number of advertisers place bids for a given advertisement impression in an auction. However, an advertiser that places a highest bid wins the auction, and will consequently display a corresponding advertisement on an associated website.

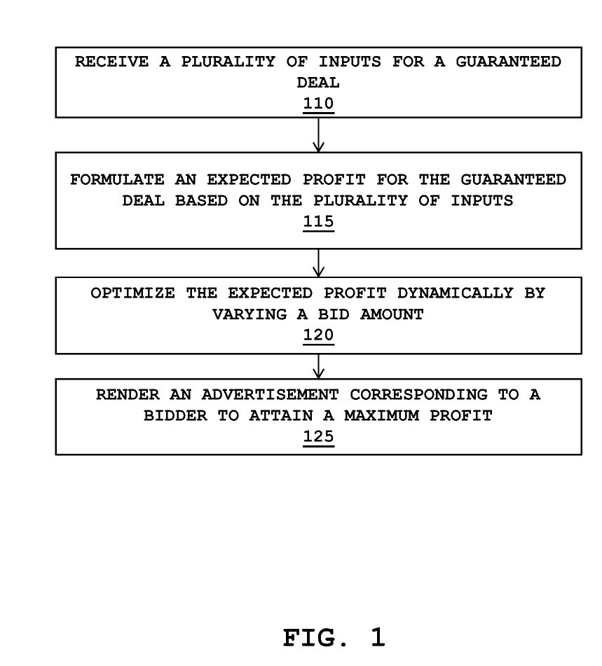

FIG. 1 is a flow diagram illustrating a method of dynamically optimizing profit for guaranteed deal bidding, in accordance with one embodiment.

At step 110, a plurality of inputs is received for a guaranteed deal.

The guaranteed deal (g) can be represented as:

g=m, e, ρ, μi

where m=required minimum number of clicks,

e=expiry time,

ρ=cost per click (CPC),

μi=click through rate (CTR).

The required minimum number of clicks (m) signifies number of clicks required on advertisements such that advertisers pay a publisher, typically a website owner, for example Yahoo and Hotmail.

The expiry time (e) signifies time when the guaranteed deal expires.

The cost per click (CPC) signifies payment made by advertisers to publishers based on the number of clicks a specific advertisement receives.

The click through rate (CTR) signifies an estimated ratio of number of times a user clicks on an advertisement to number of viewers on the advertisement.

Further, the inputs include a mechanism that performs on-line estimates of the click-through rate.

Further, the inputs received are values corresponding to m, e, ρ and μi.

At step 115, an expected profit is formulated for the guaranteed deal based on the inputs.

For the guaranteed deal, a click probability is given by,

P(click)=P(click|impression)×P(impression|bid)

A first factor, P(click|impression) signifies the CTR of the guaranteed deal. Further, the first factor is a constant. A second factor, P(impression|bid) increases along with a bid amount. Consequently, the expected profit increases with the bid amount. However, an amount paid by a bidder to the publisher (h(b)) increases with the bid amount. As a result, the expected profit tends to decrease with increase in the bid amount. Consequently, the guaranteed bid necessitates optimization considering variations of the expected profit.

For a guaranteed deal, the profit Pₜ at time t can be represented as given below:

$${𝒫}_{t} = \{ \begin{matrix}ρ {c}_{t } - {\sum }_{j = 0}^{t} h ( {b}_{j} ) {ψ}_{j} & where {c}_{t} \geq m \\ - {\sum }_{j = 0}^{t} h ( {b}_{j} ) {ψ}_{j} & where {c}_{t} < m\end{matrix} \qquad Equation ( 1 )$$

h(b) is a mapping from bids to payments. Further, h(b) depends on auction model, number of other bidders and bid distributions.

The time t signifies the time at which the user visits the website that includes the advertisement for the guaranteed deal.

Let ψₜ be a binary indicator variable with value of one if the advertiser's bid is successful at the time t and with value zero if the advertiser's bid is unsuccessful. Let Cₜ be the received clicks at time t.

The expected profit is formulated using Equation 1.

The expected profit is given by a function:

$$E ( {𝒫}_{t} ) = {c}_{t} ρΦ ( {r}_{t ;} {u}_{t ;} {b}_{t ;} μ ) + ρ ⊖ ( {r}_{t ;} {u}_{t ;} {b}_{t ;} μ ) ( {\sum }_{j = 1}^{t - 1} {ψ}_{j} h ( {b}_{j} ) + {u}_{t} d ( {b}_{t} ) h ( {b}_{t} ) ) \qquad Equation ( 2 )$$

For the guaranteed deal (g) and the number of received clicks Cₜ, a bid amount is calculated such that the expected profit from user visits uₜ is maximum. Further, uₜ is the expected number of user visits before the expiry time e.

The expected profit is derived prior to the expiry time of the guaranteed deal and is based on the current state of the guaranteed deal. In some embodiments, the expected profit can also be derived at the time of expiry.

Further, the expected profit is derived as a function of bid amount, an estimate of the likelihood of showing an impression as a function of the bid value, time to expire, fulfilled events, amount spent to buy impressions, auction mechanism, the click through rate and the number of other bidders.

The bidder is allowed to change only an associated bid amount. As a result, the expected profit is optimized with the bid amount in the next step.

The bid amount is then submitted for the guaranteed deal in the auction. Further, the bid amount maximizes the expected profit.

At step 120, the expected profit is dynamically optimized by varying the bid amount.

The expected profit in Equation 2 is optimized based on the bid amount. Further, the expected profit is dynamically optimized between time durations at which the user visits the website.

For the given guaranteed deal g=hm, e, ρ, μi and the number of received clicks cₜ, a bid amount is computed using a current state of the guaranteed deal. The bid amount maximizes the expected profit from a user uₜ. uₜ denotes the expected number of user visits before the advertisement expiry time e. Further, as time progresses, the optimal bid bt is updated frequently based on a current state and the expected number of user visits in future.

At step 125, an advertisement corresponding to the bidder is rendered to attain a maximum profit.

Consequently, the bidder wins the auction and the advertisement corresponding to the bidder is rendered on the website. In some embodiments, a user clicks with the probability equal to an estimated CTR of the guaranteed deal.

Exemplary applications of the method described are as follows:
1. Deal Selection: Deal selection illustrates maximizing expected profits by choosing a best deal to bid for every impression. The deal with maximum marginal profit by the impression is selected as the winner. Expected marginal profit is calculated as the difference between the expected profits of winning the impression and failing to win the impression.
2. Deal Admissibility: Deal admissibility illustrates predicting whether bidding for a specific deal is profitable. An advertiser can decide to accept or reject a deal campaign based on the deal admissibility.
3. Non-bidding Selection: Here, if there are no competing bidders, the publisher directly selects deals.
4. Non-guaranteed Ads: In absence of any guarantees, the expected profits fall to traditional ads. As a result, the method serves as a unified real time bidding strategy for both guaranteed and non-guaranteed ads.
5. Guaranteed Clicks: Illustrates the Click-through-rate (CTR). The CTR is the number of times an advertisement is clicked upon over the number of times the advertisement is served.
6. Guaranteed Impressions: Defines the guaranteed number of impressions.
7. Guaranteed Conversions: Defines the guaranteed conversion rate.

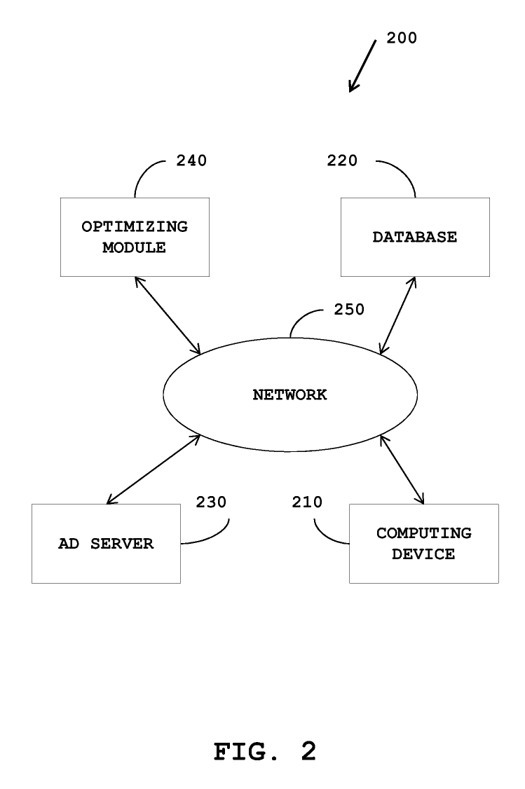

FIG. 2 is a block diagram illustrating a system for dynamically optimizing profit for guaranteed deal bidding, in accordance with one embodiment.

The system 200 can implement methods described above. The system 200 includes a computing device 210, a database 220, an ad server 230 and an optimizing module 240 in communication with a network 250 (for example, the Internet or a cellular network).

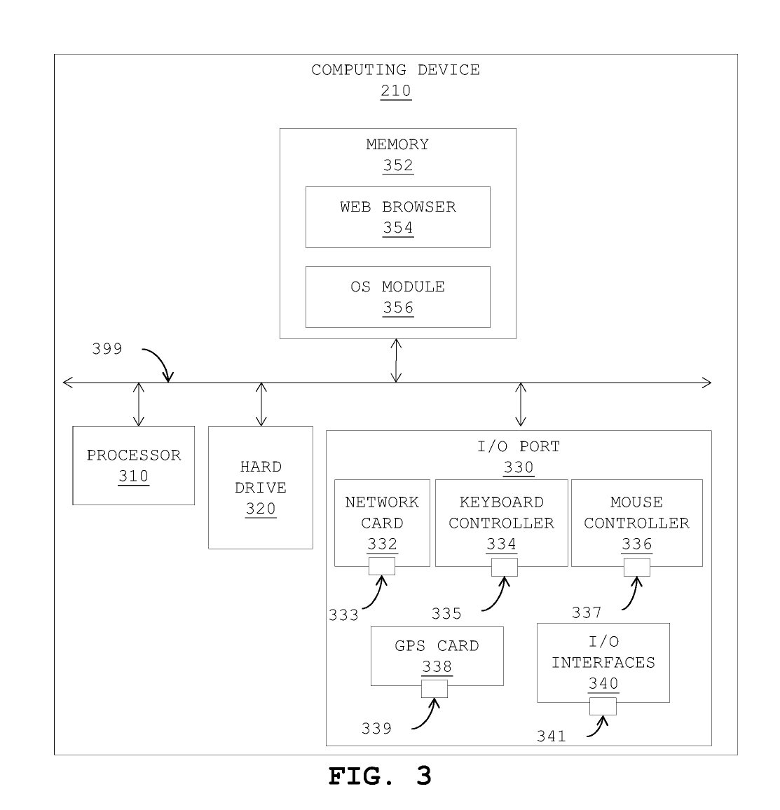

Examples of the computing device 210 include, but are not limited to, a Personal Computer(PC), a stationary computing device, a laptop or notebook computer, a tablet computer, a smart phone or Personal Digital Assistant (PDA), a smart appliance, a video gaming console, an Internet television, a set-top box, or other suitable processor-based devices that can send and view online video advertisements. In one embodiment, the computing device 210 displays an advertisement corresponding to a bidder who wins the auction. Additional embodiments of the computing device 210 are described in detail in conjunction with FIG. 3.

The database 220 stores a plurality of inputs received for a guaranteed deal.

The ad server 230 is a web server that stores online advertisements that are rendered to the user. Further, the ad server 230 selects the advertisement corresponding to the bidder who wins the auction and displays the advertisement on the website for users viewing the website.

The optimizing module 240 dynamically optimizes the expected profit based on a bid amount. The expected profit is formulated by the computing device 210.

In one embodiment, the computing device 210 receives the inputs for the guaranteed deal through a web interface. The inputs are stored in the database 220. Further, the computing device 210 formulates the expected profit for the inputs received. The expected profit is then sent to the optimizing module 240. The optimizing module 240 dynamically optimizes the expected profit against the bid amount. Further, the expected profit is optimized based on the time to expire and required number of user clicks. Subsequent to the optimization, the bid amount is submitted at the auction for the guaranteed deal. On winning the guaranteed deal, the ad server 230 renders the advertisement corresponding to the bidder who wins the guaranteed deal. The advertisement is displayed on a website for users to view. Consequently, the users click the advertisement with probabilities equal to the expected CTR of the guaranteed deal.

In some embodiments, the database 220 and the optimizing module 240 can be located in the computing device 210.

FIG. 3 is a block diagram illustrating an exemplary computing device 210, in accordance with one embodiment. The computing device 210 includes a processor 310, a hard drive 320, an I/O port 330, and a memory 352, coupled by a bus 399.

The bus 399 can be soldered to one or more motherboards. Examples of the processor 310 include, but is not limited to, a general purpose processor, an application-specific integrated circuit (ASIC), an FPGA (Field Programmable Gate Array), a RISC (Reduced Instruction Set Controller) processor, or an integrated circuit. The processor 310 can be a single core or a multiple core processor. In one embodiment, the processor 310 is specially suited for processing demands of location-aware reminders (for example, custom micro-code, and instruction fetching, pipelining or cache sizes). The processor 310 can be disposed on silicon or any other suitable material. In operation, the processor 310 can receive and execute instructions and data stored in the memory 552 or the hard drive 320. The hard drive 320 can be a platter-based storage device, a flash drive, an external drive, a persistent memory device, or other types of memory.

The hard drive 320 provides persistent (long term) storage for instructions and data. The I/O port 330 is an input/output panel including a network card 332 with an interface 333 along with a keyboard controller 334, a mouse controller 336, a GPS card 338 and I/O interfaces 340. The network card 332 can be, for example, a wired networking card (for example, a USB card, or an IEEE 802.3 card), a wireless networking card (for example, an IEEE 802.11 card, or a Bluetooth card), and a cellular networking card (for example, a 3G card). The interface 333 is configured according to networking compatibility. For example, a wired networking card includes a physical port to plug in a cord, and a wireless networking card includes an antennae. The network card 332 provides access to a communication channel on a network. The keyboard controller 334 can be coupled to a physical port 335 (for example PS/2 or USB port) for connecting a keyboard. The keyboard can be a standard alphanumeric keyboard with 101 or 104 keys (including, but not limited to, alphabetic, numerical and punctuation keys, a space bar, modifier keys), a laptop or notebook keyboard, a thumb-sized keyboard, a virtual keyboard, or the like. The mouse controller 336 can also be coupled to a physical port 337 (for example, mouse or USB port). The GPS card 338 provides communication to GPS satellites operating in space to receive location data. An antenna 339 provides radio communications (or alternatively, a data port can receive location information from a peripheral device). The I/O interfaces 340 are web interfaces and are coupled to a physical port 341.

The memory 352 can be a RAM (Random Access Memory), a flash memory, a non-persistent memory device, or other devices capable of storing program instructions being executed. The memory 352 comprises an Operating System (OS) module 356 along with a web browser 354. In other embodiments, the memory 352 comprises a calendar application that manages a plurality of appointments. The OS module 356 can be one of Microsoft Windows® family of operating systems (for example, Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64.

The web browser 354 can be a desktop web browser (for example, Internet Explorer, Mozilla, or Chrome), a mobile browser, or a web viewer built integrated into an application program. In an embodiment, a user accesses a system on the World Wide Web (WWW) through a network such as the Internet. The web browser 354 is used to download the web pages or other content in various formats including HTML, XML, text, PDF, and postscript, and may be used to upload information to other parts of the system. The web browser may use URLs (Uniform Resource Locators) to identify resources on the web and HTTP (Hypertext Transfer Protocol) in transferring files to the web.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standards 802.11, 802.11a, 802.11b, 802.11e, 802.11g, 802.11i, and 802.11n). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A computer-implemented method of dynamically optimizing profit for guaranteed deal bidding, the computer-implemented method comprising:
receiving a plurality of inputs for a guaranteed deal;
formulating an expected profit for the guaranteed deal based on the plurality of inputs;
optimizing the expected profit dynamically by varying a bid amount;
rendering an advertisement corresponding to a bidder to attain a maximum profit.

2. The computer-implemented method of claim 1, wherein the plurality of inputs comprises of required number of minimum clicks, an expiry time, a cost per click, an estimated click through rate, and a mechanism that performs on-line estimates of the click-through rate.

3. The computer-implemented method of claim 1, wherein formulating the expected profit comprises:
computing a bid amount prior to an expiry time; and
submitting the bid amount for the guaranteed deal in an auction, wherein the bid amount maximizes profit.

4. The computer-implemented method of claim 3, wherein the bid amount is computed using a current state of the guaranteed deal.

5. The computer-implemented method of claim 1, wherein formulating the expected profit is based on one of a bid value, an estimate of the likelihood of showing an impression as a function of the bid value, an expiry time, fulfilled events, amount spent to buy impressions, auction mechanism, click through rate and number of bidders.

6. The computer-implemented method of claim 1, wherein optimizing the expected profit is performed at one of expiry time and time when a user visits a web page.

7. The computer-implemented method of claim 1, wherein the displaying further comprises
winning the guaranteed deal.

8. The computer-implemented method of claim 1 and further comprising
updating the bid amount dynamically based on a current state of the guaranteed deal.

9. A computer program product stored on a non-transitory computer-readable medium that when executed by a processor, performs a method for dynamically optimizing profit for guaranteed deal bidding, comprising:
receiving a plurality of inputs for a guaranteed deal;
formulating an expected profit for the guaranteed deal based on the plurality of inputs;
optimizing the expected profit dynamically by varying a bid amount; and
rendering an advertisement corresponding to a bidder to attain a maximum profit.

10. The computer program product of claim 9, wherein the plurality of inputs comprises of required number of minimum clicks, an expiry time, a cost per click, an estimated click through rate, and a mechanism that performs on-line estimates of the click-through rate.

11. The computer program product of claim 9, wherein formulating the expected profit comprises:
computing a bid amount prior to the expiry time; and
submitting the bid amount for the guaranteed deal in an auction, wherein the bid amount maximizes profit.

12. The computer program product of claim 11, wherein the bid amount is computed using a current state of the guaranteed deal.

13. The computer program product of claim 9, wherein formulating the expected profit is based on one of a bid value, an estimate of the likelihood of showing an impression as a function of the bid value, expiry time, fulfilled events, amount spent to buy impressions, auction mechanism, click through rate and the number of bidders.

14. The computer program product of claim 9, wherein optimizing the expected profit is performed at one of expiry time and time when the user visits a web page.

15. The computer program product of claim 9, wherein the displaying further comprises:
winning the guaranteed deal.

16. The computer program product of claim 9 and further comprising:
updating the bid amount dynamically based on a current state of the guaranteed deal.

17. A system for dynamically optimizing profit for guaranteed deal bidding, the system comprising:
a web interface that receives a plurality of inputs for a guaranteed deal;
a computing device that formulates an expected profit for the guaranteed deal based on the plurality of inputs; and
an ad server, in electronic communication with the web interface that stores advertisements and renders the advertisements.

18. The system of claim 17 and further comprising:
an optimizing module that optimizes the expected profit dynamically by varying a bid amount.

19. The system of claim 17 and further comprising:
a database, in electronic communication with the web interface that stores the plurality of inputs.
